(19) United States
(12) Patent Application Publication
(10) Pub. No.: US 2020/0275084 A1
(43) Pub. Date: Aug. 27, 2020

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Michio Aizawa, Yokohama-shi (JP)

(21) Appl. No.: 16/795,036

(22) Filed: Feb. 19, 2020

(30) Foreign Application Priority Data
Feb. 27, 2019 (JP) 2019-033570

(51) Int. Cl. H04N 13/282; H04N 13/296; H04N 13/279; H04N 13/243

(52) U.S. Cl. CPC H04N 13/282; H04N 13/243; H04N 13/279; H04N 13/296

(57) ABSTRACT

A parameter set specification unit of an information processing apparatus specifies a virtual viewpoint parameter set included in virtual viewpoint information obtained by a camera path obtaining unit. A camera path modification unit modifies a virtual viewpoint parameter included in the specified virtual viewpoint parameter set based on at least either a size of an object region included in a virtual viewpoint image corresponding to the specified virtual viewpoint parameter set or information for determining the size.

### BACKGROUND

### Field

The present disclosure relates to a technique for setting virtual viewpoint information.

### Description of the Related Art

A technique for synchronously capturing images from a plurality of viewpoints with a plurality of imaging apparatuses installed at different positions and generating a virtual viewpoint image based on a freely set viewpoint by using the images captured from the plurality of viewpoints has attracted attention in recent years.

Using such a technique for generating a virtual viewpoint image, video creators can create contents with an impressive viewpoint, for example, from video images captured in a soccer or rugby game. Users viewing the contents can also watch the game by freely moving the viewpoint by themselves, which can give the users high realistic sensation compared to conventionally captured images.

Japanese Patent Application No. 2017-142755 discusses a technique for generating a virtual viewpoint image.

However, conventional techniques have had an issue of difficulty in efficiently modifying information for generating a virtual viewpoint image (such as information about transition of the position and direction of the virtual viewpoint; hereinafter, may also be referred to as virtual viewpoint information). For example, if a virtual viewpoint image is generated based on set virtual viewpoint information, modification of the virtual viewpoint information may sometimes be desirable in a case where a foreground region in the virtual viewpoint image becomes excessively large. In such a case, according to the conventional techniques, the user manually specifies the amount of modification to the virtual viewpoint information. Manually specifying the amount of modification is inefficient because it takes long to modify the virtual viewpoint information.

### SUMMARY

The present disclosure is directed to enabling efficient modification of virtual viewpoint information.

According to an aspect of the present disclosure, an information processing apparatus includes an obtaining unit configured to obtain a virtual viewpoint parameter set including at least either a virtual viewpoint parameter indicating a position of a virtual viewpoint or a virtual viewpoint parameter indicating a direction from the virtual viewpoint, the virtual viewpoint being related to a virtual viewpoint image based on a plurality of captured images obtained by capturing images of an imaging area in different directions by a plurality of imaging apparatuses, and a modification unit configured to modify the virtual viewpoint parameter(s) included in the virtual viewpoint parameter set obtained by the obtaining unit based on a user operation made after the virtual viewpoint parameter set is obtained by the obtaining unit and information for determining a size of a foreground region corresponding to a predetermined object in the imaging area, the foreground region being included in the virtual viewpoint image corresponding to the virtual viewpoint parameter set obtained by the obtaining unit.

Further features of the present disclosure will become apparent from the following description of exemplary embodiments with reference to the attached drawings.

### BRIEF DESCRIPTION OF THE DRAWINGS

FIG. 1 is a diagram illustrating a hardware configuration of an information processing apparatus according to one or more aspects of the present disclosure.

FIG. 2 is a diagram illustrating a functional configuration of the information processing apparatus according to one or more aspects of the present disclosure.

FIG. 3 is a diagram illustrating an example of layout of imaging apparatuses and a virtual camera.

FIG. 4 is a diagram illustrating a user interface (UI) for setting virtual viewpoint information according to one or more aspects of the present disclosure.

FIG. 5 is a flowchart illustrating a processing procedure of the information processing apparatus according to one or more aspects of the present disclosure.

FIGS. 6A and 6B are diagrams illustrating examples of a virtual viewpoint image according to one or more aspects of the present disclosure.

FIGS. 7A and 7B are diagrams illustrating an example of a case where the virtual viewpoint information is modified.

FIG. 8 is a diagram illustrating a UI for setting virtual viewpoint information according to one or more aspects of the present disclosure.

FIG. 9 is a diagram illustrating a functional configuration of an information processing apparatus according to one or more aspects of the present disclosure t.

FIG. 10 is a diagram illustrating an example of a case where modification to virtual viewpoint information is cancelled.

FIG. 11 is a flowchart illustrating a processing procedure of a cancellation determination unit.

FIG. 12 is a diagram illustrating an example of a camera path.

### DESCRIPTION OF THE EMBODIMENTS

Exemplary embodiments will be described below with reference to the drawings.

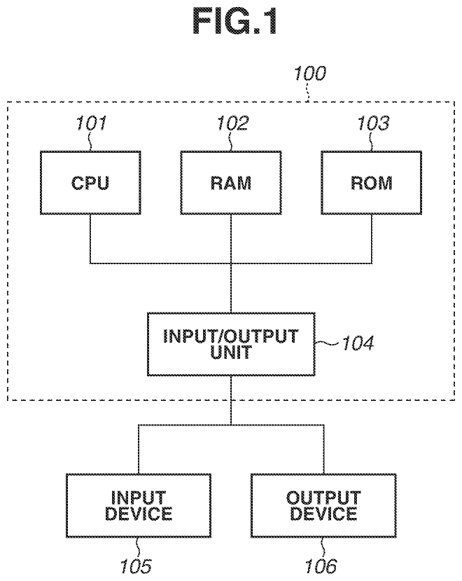

FIG. 1 is a diagram illustrating a hardware configuration of an information processing apparatus 100 according to a first exemplary embodiment. The information processing apparatus 100 includes a central processing unit (CPU) 101, a random access memory (RAM) 102, a read-only memory (ROM) 103, and an input/output unit 104. Each component will be described below.

The CPU 101 controls the entire information processing apparatus 100 by using computer programs and data stored in the RAM 102 and the ROM 103. The information processing apparatus 100 may include one or a plurality of pieces of dedicated hardware or a graphics processing unit (GPU) different from the CPU 101, and at least part of the processing of the CPU 101 may be performed by the GPU or the dedicated hardware. Examples of the dedicated hardware include an application specific integrated circuit (ASIC) and a digital signal processor (DSP). The CPU 101 also performs recording control processing for recording computer programs and data read from the ROM 103 and data supplied from outside via the input/output unit 104 into the RAM 102. The RAM 102 temporarily stores the computer programs and data read from the ROM 103 and the data supplied from outside via the input/output unit 104. The ROM 103 stores computer programs and data that will not be changed. The input/output unit 104 inputs and outputs data from/to an input device 105 and an output device 106 connected to the information processing apparatus 100. An example of the input device 105 is a controller including an operation member such as a joystick and a button. An example of the output device 106 is a display. The output device 106 displays processing results corresponding to user operations, as well as images. The information processing apparatus 100 may include the input device 105 and the output device 106.

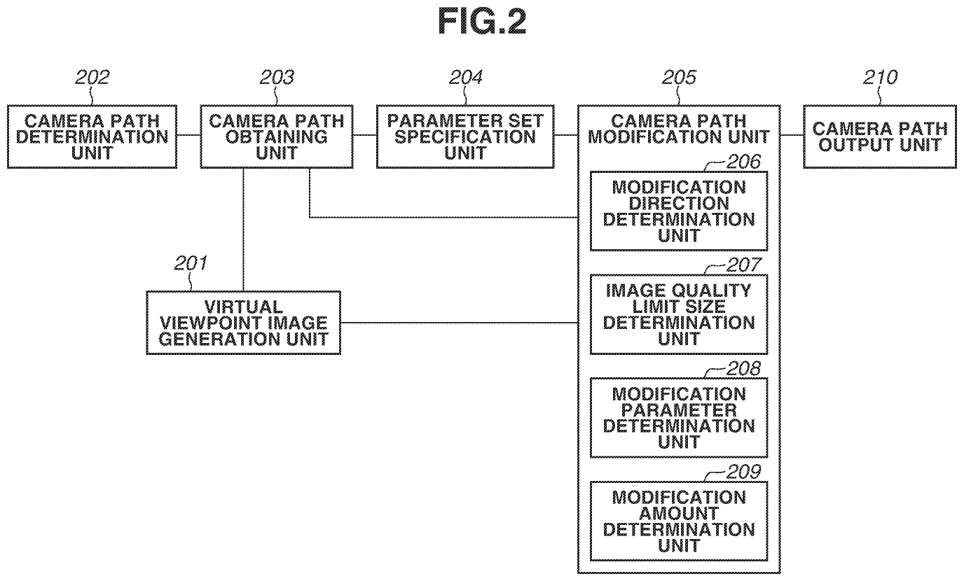

FIG. 2 is a diagram illustrating a functional configuration of the information processing apparatus 100 according to the present exemplary embodiment. The information processing apparatus 100 includes a virtual viewpoint image generation unit 201, a camera path determination unit 202, a camera path obtaining unit 203, a parameter set specification unit 204, a camera path modification unit 205, and a camera path output unit 210. The functions of the units will be described below.

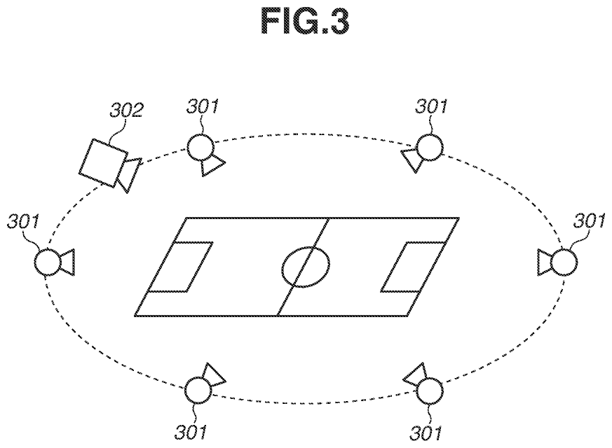

The virtual viewpoint image generation unit 201 (hereinafter, referred to as an image generation unit 201) generates a virtual viewpoint image corresponding to a virtual viewpoint based on a plurality of images captured by a plurality of imaging apparatuses. FIG. 3 illustrates an example of layout of imaging apparatuses 301. The plurality of imaging apparatuses 301 is arranged to surround an imaging space. The image generation unit 201 according to the present exemplary embodiment generates a virtual viewpoint image based on model-based rendering. Specifically, the image generation unit 201 extracts foreground regions from each of a plurality of captured images captured by the plurality of imaging apparatuses 301. In the present exemplary embodiment, a foreground region refers to an object region in a captured image, a region corresponding to a predetermined object (such as a player and a ball; hereinafter, referred to as a foreground object) that changes in position within an imaging area captured by the imaging apparatuses 301. A background region refers to the region other than the foreground region in an image. Based on the images of a plurality of foreground regions, the image generation unit 201 estimates (identifies) the three-dimensional shape and position of an object (such as a player and a ball) corresponding to the foreground regions. The image generation unit 201 then generates a virtual viewpoint image based on information about the three-dimensional shape and position of the foreground object, information about the background regions, and virtual viewpoint information. The method for generating the virtual viewpoint image is not limited to the foregoing. For example, a method for generating a virtual viewpoint image based on image-based rendering may be employed. The image generation unit 201 also performs presentation control for controlling visual presentation of the generated virtual viewpoint image and the virtual viewpoint information to the user by the output device 106. The image generation unit 201 here may simply display the generated virtual viewpoint image on the output device 106, or numerically display virtual viewpoint parameters included in a camera path determined by the camera path determination unit 202 to be described below. The image generation unit 201 may display a transition path of the virtual viewpoint by using arrows. The user can recognize the transition of the virtual viewpoint from the information presented by the output device 106.

The camera path determination unit 202 determines a camera path in the imaging space based on user operations such as a joystick operation. A camera path refers to virtual viewpoint information that includes a plurality of parameters of a virtual camera and represents the transition of the virtual viewpoint with the plurality of parameters. A virtual camera is a camera that is different from the plurality of imaging apparatuses actually installed around the imaging area and is virtual, i.e., a concept for convenient description of the virtual viewpoint. In other words, the virtual viewpoint image generated by the image generation unit 201 can be regarded as an image captured from the virtual viewpoint set within a virtual space associated with the imaging area. The parameters of the virtual camera are associated with virtual viewpoint parameters. Specifically, the position of the virtual camera is a parameter corresponding to the position of the virtual viewpoint. The direction (imaging direction) of the virtual camera is a parameter corresponding to the direction of the virtual viewpoint. A focal length of the virtual camera is a parameter corresponding to an angle of view at the virtual viewpoint. The smaller the focal length of the virtual camera, the greater the angle of view at the virtual viewpoint. The greater the focal length of the virtual camera, the smaller the angle of view at the virtual viewpoint. In other words, the virtual viewpoint image can be said to be an image captured by the virtual camera at the position of the virtual viewpoint in the virtual space. FIG. 3 illustrates an example of layout of the virtual camera 302. The virtual camera 302 can capture an image of the imaging area from a viewpoint different from any of those of the imaging apparatuses 301. User operations made for the camera path determination unit 202 to determine the camera path will hereinafter be referred to as determination operations.

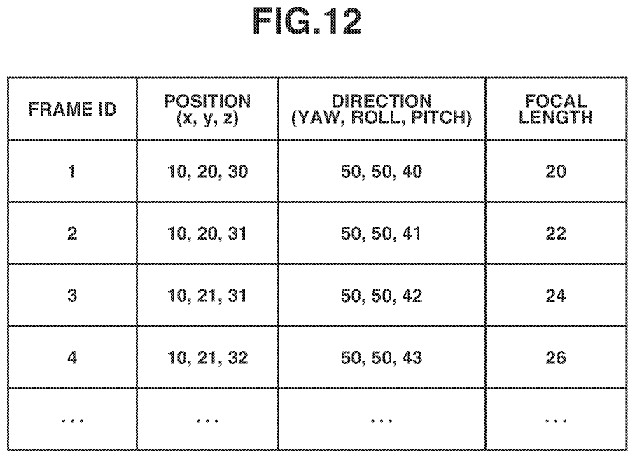

The camera path includes a plurality of parameters of the virtual camera 302 determined at predetermined time intervals. For example, suppose that the camera path determination unit 202 determines a camera path including parameters indicating the position, direction, and focal length of the virtual camera 302. If virtual viewpoint images are generated at 60 frames/sec, the information about the position, direction, and focal length of the virtual camera 302 is determined as parameters at every 1/60 sec. In other words, a camera path for 1 sec includes 60 parameters indicating each of the position, direction, and focal length of the virtual camera 302 in the respective frames. As employed herein, the predetermined time refers to the playback duration of a moving image generated based on a plurality of captured images captured by the plurality of imaging apparatuses 301. Here, the imaging period of the imaging apparatuses 301 can be a duration of any length or a point in time. For example, a moving image captured by the virtual camera 302 can be generated based on captured images captured by the imaging apparatuses 301 at a point in time. That is, the camera path represents the transition of the virtual viewpoint expressed by the moving image generated based on the captured images captured by the imaging apparatuses 301 in an imaging period. FIG. 12 illustrates an example of the camera path. Parameters indicating a position, direction, and focal length are associated with a frame identifier (ID). Specifically, the camera path determination unit 202 determines a combination of parameters of the virtual camera 302 at each predetermined time (for each frame ID). The parameters of the virtual camera 302 included in the camera path are not limited to the combination of the position, direction, and focal length. The parameters of the virtual camera 302 included in the camera path may include at least either the parameter indicating the position or the parameter indicating the direction. For example, if the camera path includes no parameter indicating the “direction”, the camera path expresses the transition of a virtual viewpoint that remains unchanged in the direction of viewpoint. If the camera path includes no parameter indicating the “position”, the camera path expresses the transition of a virtual viewpoint at a fixed viewpoint position. In the following description of the present exemplary embodiment, the camera path is determined to include the combination of the parameters indicating the position, direction, and focal length of the virtual camera 302 as an example. The combination of the parameters of the virtual camera 302 (in the present exemplary embodiment, the combination of the parameters including the position, direction, and focal length of the virtual camera 302) will hereinafter be referred to as a virtual viewpoint parameter set or simply as a parameter set.

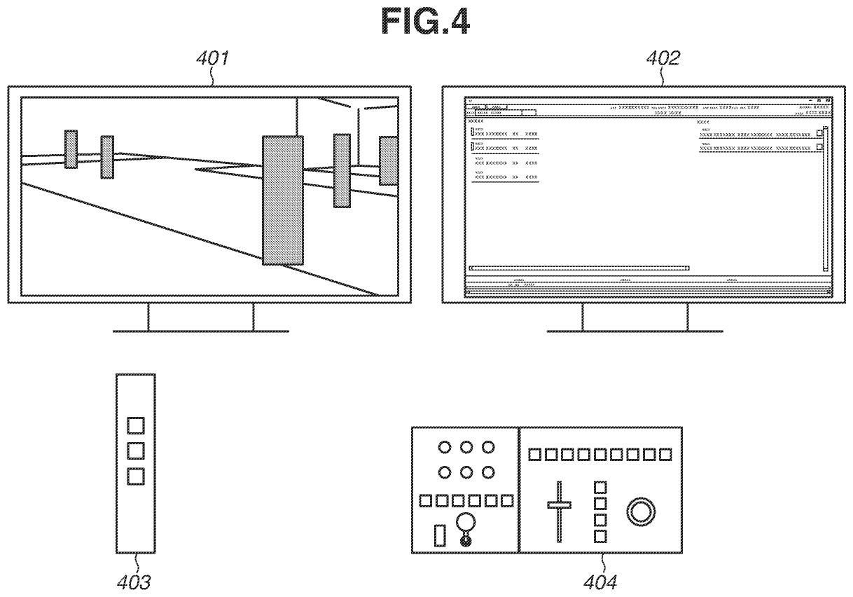

An example of a user interface (UI) for determining the camera path will be described with reference to FIG. 4. A specification controller 403 and a camera controller 404 in FIG. 4 are examples of the input device 105. A virtual viewpoint image display unit 401 and a display 402 in FIG. 4 are examples of the output device 106. A camera operator makes operations (determination operations) for determining the camera path by using the camera controller 404. By using the camera controller 404, the camera operator can make the following operations on the virtual camera 302; move the virtual camera 302 back and forth, left and right, and up and down; and rotate the virtual camera 302 in pan, tilt, and roll directions. The camera operator can also change the frame ID to determine a parameter set with (move back or forth in time) on the camera path under determination by using the camera controller 404. The parameter set representing the position, direction, and focal length of the virtual camera 302 operated by the camera operator is transmitted to the image generation unit 201, which generates a virtual viewpoint image. The generated virtual viewpoint image is displayed on the virtual viewpoint image display unit 401. In other words, the camera operator can make determination operations while viewing virtual viewpoint images. The display 402 displays, for example, information about captured scenes on the camera path under determination, video clips of the video image captured by the virtual camera 302, and information about imaging times of the virtual camera 302.

The camera path obtaining unit 203 obtains the camera path determined by the camera path determination unit 202. The obtained camera path is transmitted to the parameter set specification unit 204 and the camera path modification unit 205 to be described below. The camera path obtaining unit 203 may obtain a camera path from an external server connected.

The parameter set specification unit 204 specifies a parameter set including a parameter to be modified from among the parameter sets included in the camera path based on user operations such as a button operation. The user operations made for the parameter set specification unit 204 to specify a parameter set will be referred to as specification operations. The specification operations are user operations different from the determination operations, and performed while the camera path is presented to the user by the image generation unit 201. The parameter set specification unit 204 also records information for identifying the specified parameter set (hereinafter, referred to as identification information). For example, in a case where a specification operation is detected when a parameter set corresponding to a frame ID=5 is being referred to, identification information “frame ID=5” is recorded. The identification information may be any information that can identify the parameter set including the parameter to be modified on the camera path. For example, the identification information may be imaging time information about the virtual camera 302, or information about an elapsed time of the video image captured by the virtual camera 302 from the beginning. The identification information may be expressed by a combination of any of the frame ID, the imaging time information about the virtual camera 302, and the information about the elapsed time of the video image captured by the virtual camera 302 from the beginning.

An example of a UI for recording identification information will be described with reference to FIG. 4. The camera path obtaining unit 203 obtains the camera path determined by the camera path determination unit 202. The virtual viewpoint images related to the camera path obtained by the camera path obtaining unit 203 are displayed on the virtual viewpoint image display unit 401. A modification operator makes specification operations by using the specification controller 403 while viewing the virtual viewpoint image display unit 401. The modification operator viewing the virtual viewpoint image display unit 401 may intend to modify a virtual viewpoint image due to reasons such as that the virtual viewpoint image is different from what is expected and that the modification operator wishes to make a correction. The modification operator presses a button on the specification controller 403 when a virtual viewpoint image to be modified is found. If the pressing of the button (specification operation) is detected, the parameter set specification unit 204 records the information (identification information) for identifying the parameter set determined by the timing of pressing of the button on the camera path determined by the camera path determination unit 202. In such a manner, the modification operator can make specification operations while the determination of the camera path by the camera path determination unit 202 is in process. In the present exemplary embodiment, the operator who makes determination operations (camera operator) and the operator who makes specification operations (modification operator) are assumed to be different. However, determination operations and specification operations may be performed by the same person. At least either determination operations or specification operations may be performed by a plurality of operators. Aside from the foregoing example, the modification operator can make specification operations while viewing an image indicating the camera path (image in a table form or a bird's eye view) presented by the output device 106. In other words, the modification operator can make specification operations while the virtual viewpoint information is presented in the form of virtual viewpoint images or an image indicating the camera path.

Examples of a scene where modification of the parameters of the virtual camera 302 is desirable include where the foreground region in a virtual viewpoint image becomes too large and the image quality of the virtual viewpoint image degrades compared to normal conditions. As employed herein, the size of a foreground region is expressed by a size corresponding to the foreground region in the virtual viewpoint image or by the proportion of the foreground region to the entire virtual viewpoint image. For example, the size corresponding to the foreground region in the virtual viewpoint image is expressed by the number of pixels of the foreground region or the area of a rectangular or other figure surrounding the foreground region. The size of the foreground region may be determined by information indicating the length of the foreground region in one direction (for example, a long-side direction), such as the height of the foreground region in the virtual viewpoint image. As the size of the foreground region corresponding to the same foreground object increases in a virtual viewpoint image, the image quality of the virtual viewpoint image typically degrades due to a similar effect to digital zooming. In such a case, for example, the image quality can be improved by moving the virtual camera 302 in a “direction of making the foreground region smaller”. In other words, the image quality can be improved by modifying the parameters to shift the virtual camera 302 in the “direction of making the foreground region smaller”. On the other hand, a virtual viewpoint image can appear weak if the foreground region in the virtual viewpoint image is too small. In such a case, for example, the issue of weakness can be improved by modifying the parameters to shift the virtual camera 302 in a “direction of making the foreground region greater”. The camera path modification unit 205 can thus modify the parameters more appropriately in the processing of the camera path modification unit 205 to be described below if operations for specifying whether to make the foreground region larger or smaller are added when the modification operator makes specification operations. The directions of change of the virtual camera 302 may also include directions other than the “direction of making the foreground region smaller” and the “direction of making the foreground region greater” described above. An example of a UI with the additional operations for specifying the direction of change of the virtual camera 302 is described below. The modification operator operates a three-button specification controller 403. If a first button is pressed, only the identification information is recorded. If a second button is pressed, the “direction of making the foreground region smaller” is recorded as the direction of change of the virtual camera 302, along with the identification information. If a third button is pressed, the “direction of making the foreground region greater” is recorded as the direction of change of the virtual camera 302, along with the identification information. However, this example is not restrictive. For example, the specification controller 403 may include only the first button. Alternatively, the specification controller 403 may include only the second and third buttons.

Examples of the method for shifting the virtual camera 302 in the direction of making the foreground region smaller or greater include a method for modifying the position of the virtual camera 302 and a method for modifying the focal length of the virtual camera 302. The parameters can be modified in a more desirable manner by adding operations for specifying which to modify, the parameter indicating the “position” (hereinafter, may be referred to as the parameter “position” or simply as the “position”) of the virtual camera 302 or the parameter indicating the “focal length” (hereinafter, may be referred to as the parameter “focal length” or simply as the “focal length”) of the virtual camera 302, when the modification operator makes specification operations. An example of a UI with the additional operations for specifying the parameter to be modified is described below. The modification operator operates a three-button specification controller 403. If a first button is pressed, only the identification information is recorded. If a second button is pressed, the “position” is recorded as the parameter to be modified, along with the identification information. If a third button is pressed, the “focal length” is recorded as the parameter to be modified, along with the identification information. However, this example is not restrictive, either. For example, the specification controller 403 may include only the first button. Alternatively, the specification controller 403 may include only the second and third buttons.

The parameter set specification unit 204 may be configured to specify the identification information, the direction of change of the virtual camera 302, and the parameter to be modified. For example, the modification operator may operate a specification controller 403 that includes a total of four buttons, two for specifying the direction and two for specifying the parameter. All the combinations can be specified by enabling pressing of a button for specifying the direction and a button for specifying the parameter.

The camera path modification unit 205 modifies the parameter set corresponding to the identification information recorded by the parameter set specification unit 204, and sets the settled camera path. The camera path modification unit 205 includes a modification direction determination unit 206, an image quality limit size determination unit 207, a modification parameter determination unit 208, and a modification amount determination unit 209. The components of the camera path modification unit 205 will be described below.

The modification direction determination unit 206 determines the direction of change of the virtual camera 302 corresponding to the identification information. If the direction of change of the virtual camera 302 is specified by the parameter set specification unit 204, the modification direction determination unit 206 determines the direction as the direction of modification. If no direction is specified by the parameter set specification unit 204, the modification direction determination unit 206 determines the “direction of making the foreground region smaller” as the direction of change of the virtual camera 302. The purpose is to prevent a drop in the image quality of the virtual viewpoint image. The modification direction determination unit 206 may be preset so that a predetermined direction is determined as the direction of change of the virtual camera 302 if no direction is specified by the parameter set specification unit 204.

The modification direction determination unit 206 may be configured to determine the direction of change of the virtual camera 302 based on the size of the foreground region in the virtual viewpoint image and an image quality limit size of the foreground region to be described below. In such a case, the modification direction determination unit 206 compares the size of the foreground region in the virtual viewpoint image with the image quality limit size of the foreground region. If the size of the foreground region in the virtual viewpoint image is greater than the image quality limit size, the modification direction determination unit 206 determines the “direction of making the foreground region smaller” as the direction of change of the virtual camera 302. If the size of the foreground region in the virtual viewpoint image is smaller than the image quality limit size, the modification direction determination unit 206 determines the “direction of making the foreground region greater” as the direction of change of the virtual camera 302.

The image quality limit size determination unit 207 determines the maximum size of a foreground region in a virtual viewpoint image at which image quality degradation of the foreground region is allowable as the image quality limit size. For example, the image quality limit size of the foreground region is determined based on a size corresponding to the foreground region in the captured image captured by an imaging apparatus 301 or the proportion of the foreground region in the entire captured image. The number of pixels of the foreground region and the proportion of the foreground region in the entire captured image can be obtained from the foreground region extracted by the image generation unit 201. The image quality limit size of the foreground region has different values depending on the layout and settings of the imaging apparatus 301. For example, if the focal length of the imaging apparatus 301 is set to a telephotographic side, the image quality limit size of the foreground region increases. On the other hand, if the focal length of the imaging apparatus 301 is set to a wide angle side, the image quality limit size of the foreground region decreases. As an example of the method for determining the image quality limit size, the image quality limit size determination unit 207 determines the image quality limit size based on the settings of the imaging apparatus 301 located closest to the virtual camera 302 and the size of the foreground region in the captured image captured by the imaging apparatus 301. The image quality limit size may be determined based on the height of the foreground region at which image degradation is allowable in the virtual viewpoint image. In the present exemplary embodiment, one value is determined as the image quality limit size. However, the image quality limit size may be expressed as a range of values. In such a case, for example, the image quality limit size determination unit 207 may be configured to modify a parameter to make the foreground region greater or smaller if a value indicating the size of the foreground region in the virtual viewpoint image falls within the range of values indicated by the image quality limit size. A range of values at which a parameter is modified to make the foreground region greater may be set separately from a range of values at which the parameter is modified to make the foreground region smaller.

The modification parameter determination unit 208 determines the parameter to be modified in the parameter set corresponding to the identification information. In a case where the parameter to be modified is specified by the parameter set specification unit 204, the modification parameter determination unit 208 determines the parameter as the one to be modified. If no parameter is specified by the parameter set specification unit 204, the modification parameter determination unit 208 determines the “position” as the parameter to be modified. The modification parameter determination unit 208 may be preset so that a predetermined parameter is determined as the parameter to be modified if no parameter to be modified is specified by the parameter set specification unit 204. This does not apply if the parameters included in the parameter set are not the combination of the parameters indicating the position, direction, and focal length. For example, if the parameter indicating the “position” is not included in the parameter set, the modification parameter determination unit 208 determines the “focal length” as the parameter to be modified. If the parameter indicating the “focal length” is not included in the parameter set, the modification parameter determination unit 208 determines the “position” as the parameter to be modified.

If the parameter “position” included in the parameter set corresponding to the identification information is to be modified, the camera path modification unit 205 modifies the parameter in the following manner. In the case of shifting the virtual camera 302 in the “direction of making the foreground region smaller”, the camera path modification unit 205 modifies the parameter so that the virtual camera 302 moves back along its optical axis. In the case of shifting the virtual camera 302 in the “direction of making the foreground region greater”, the camera path modification unit 205 modifies the parameter so that the virtual camera 302 moves forward along the optical axis. If the parameter “focal length” included in the parameter set is to be modified, the camera path modification unit 205 modifies the parameter in the following manner. In the case of shifting the virtual camera 302 in the “direction of making the foreground region smaller”, the camera path modification unit 205 modifies the parameter so that the focal length of the virtual camera 302 decreases. In the case of shifting the virtual camera 302 in the “direction of making the foreground region greater”, the camera path modification unit 205 modifies the parameter so that the focal length of the virtual camera 302 increases.

The modification parameter determination unit 208 may be configured to determine the parameter of the virtual viewpoint to be modified based on virtual viewpoint images corresponding to the parameter sets associated with the frame IDs previous and next to the frame ID corresponding to the parameter set specified by the parameter set specification unit 204. In such a case, the modification parameter determination unit 208 determines the amount of change in the position of the virtual camera 302 between the virtual viewpoint images based on the virtual viewpoint images corresponding to the parameter sets previous and next to the specified parameter set. The modification parameter determination unit 208 also determines the amount of change in the focal length of the virtual camera 302 between the virtual viewpoint images based on the virtual viewpoint images corresponding to the parameter sets previous and next to the specified parameter set. The modification parameter determination unit 208 then compares the determined amount of change in position with the determined amount of change in the focal length. If the amount of change in position is greater, the “position” is determined as the parameter to be modified. If the amount of change in the focal length is greater, the “focal length” is determined as the parameter to be modified. Examples where such a configuration is effective will be described. Take, for example, a scene where a player shoots the ball in a soccer game, and the virtual camera 302 moves around the player. The corresponding camera path includes large changes in the position of the virtual camera 302 and small changes in the focal length. Such a camera path can be made smoother by modifying the position of the virtual camera 302. As another example, take a scene in the 100 meters, where the virtual camera 302 is fixed at the goal position to capture an image of coming athletes. The corresponding camera path includes large changes in the focal length of the virtual camera 302 and small changes in position. Such a camera path can be made smoother by modifying the focal length of the virtual camera 302.

The modification amount determination unit 209 determines the amount of modification to the parameter determined by the modification parameter determination unit 208. Several examples of the method for determining the amount of modification to the parameter are described below. Note that the amount of modification does not necessarily need to be determined as in the following examples.

In a case where the “position” of the virtual camera 302 is to be modified, the modification amount determination unit 209 determines the amount of modification based on a positional relationship between the virtual camera 302 and the foreground object corresponding to the foreground region in the virtual viewpoint image corresponding to the virtual camera 302. Specifically, the modification amount determination unit 209 determines the amount of modification based on the distance between the virtual camera 302 and the foreground object. The distance between the virtual camera 302 and the foreground object will be denoted by L1, and a predetermined coefficient by α (>1). In the case of shifting the virtual camera 302 in the “direction of making the foreground region smaller”, the modification amount determination unit 209 modifies the parameter “position” included in the parameter set so that the distance between the virtual camera 302 and the foreground object becomes α times. That is, the amount of modification is (α−1)× L1. In the case of shifting the virtual camera 302 in the “direction of making the foreground region greater”, the modification amount determination unit 209 modifies the parameter “position” included in the parameter set so that the distance between the virtual camera 302 and the foreground object becomes 1/α times. That is, the amount of modification is (1−1/α)× L1. If the “position” is to be modified, the modification amount determination unit 209 may determine the amount of modification based on the distance between the virtual camera 302 and a point of interest of the virtual camera 302 (hereinafter, referred to as a point of interest). The point of interest is a point on the optical axis of the virtual camera 302. An example of the point of interest of the virtual camera 302 is a point at which the optical axis of the virtual camera 302 intersects with the foreground object or an object corresponding to the background region.

If the “focal length” of the virtual camera 302 is to be modified, the modification amount determination unit 209 determines the amount of modification based on the focal length of the virtual camera 302. The focal length of the virtual camera 302 will be denoted by L2, and a predetermined coefficient by β (>1). In the case of shifting the virtual camera 302 in the “direction of making the foreground region smaller”, the modification amount determination unit 209 modifies the parameter “focal length” included in the parameter set so that the focal length of the virtual camera 302 becomes 1/β times. That is, the amount of modification is (1−1/β)×L2. In the case of shifting the virtual camera 302 in the “direction of making the foreground region greater”, the modification amount determination unit 209 modifies the parameter “focal length” included in the parameter set so that the focal length of the virtual camera 302 becomes β times. That is, the amount of modification is (β−1)×L2.

The modification amount determination unit 209 may determine the amount of modification to the parameter based on the image quality limit size and the size of the foreground region included in the virtual viewpoint image corresponding to the parameter set specified by the parameter set specification unit 204. An example where the “position” of the virtual camera 302 is modified so that the size of the foreground region in the virtual viewpoint image coincides with the image quality limit size of the foreground region will be described. The size of the foreground region captured by the virtual camera 302 will be denoted by H, the image quality limit size of the foreground region by Max, and the distance between the virtual camera 302 and the foreground object by L3. Here, the modification amount determination unit 209 determines the amount of modification so that the distance L3 between the virtual camera 302 and the foreground object becomes H/Max times. In the case of shifting the virtual camera 302 in the “direction of making the foreground region smaller” (H>Max), the amount of modification is (H/Max−1)×L3. In the case of shifting the virtual camera 302 in the “direction of making the foreground region greater” (H<Max), the amount of modification is (1−H/Max)×L3.

A case where the “focal length” of the virtual camera 302 is modified based on the image quality limit size of the foreground region will be described. The size of the foreground region captured by the virtual camera 302 will be denoted by H, the image quality limit size of the foreground region by Max, and the focal length of the virtual camera 302 by L4. Here, the modification amount determination unit 209 determines the amount of modification so that the focal length L4 of the virtual camera 302 becomes Max/H times. In the case of shifting the virtual camera 302 in the “direction of making the foreground region smaller” (H>Max), the amount of modification is (1−Max/H)×L4. In the case of shifting the virtual camera 302 in the “direction of making the foreground region greater” (H<Max), the amount of modification is (Max/H−1)×L4.

The components of the camera path modification unit 205 have been described above. The camera path modification unit 205 modifies a parameter included in the parameter set corresponding to the identification information based on the direction of change of the virtual camera 302, the parameter to be modified, and the amount of modification to the parameter that are determined by the components. If no parameter set is specified by the parameter set specification unit 204, the camera path modification unit 205 sets the camera path obtained by the camera path obtaining unit 203 as a settled camera path. If a specification operation for specifying a parameter set is detected while determination operations for determining the camera path are being made (camera path determination processing), the camera path modification unit 205 according to the present exemplary embodiment modifies the parameters after the camera path determination unit 202 ends the camera path determination processing. However, this example is not restrictive. Specifically, in a case where a specification operation is detected, the camera path modification unit 205 may modify the parameters during the camera path determination processing of the camera path determination unit 202.

The camera path modification unit 205 may have a function of modifying a parameter included in the specified parameter set and further modifying a plurality of parameter sets including the specified parameter set to make the overall camera path smooth. A case where the parameter “position” included in the specified parameter set is modified will be described as an example. The camera path modification unit 205 calculates an angle γ formed between the lines connecting the position of the virtual camera 302 related to the specified parameter set to the positions of the virtual camera 302 related to the parameter sets associated with the frame IDs previous and next to the frame ID corresponding to the specified parameter set. If the angle γ is less than or equal to 900, the camera path modification unit 205 modifies the previous and next, two positions of the virtual camera 302 so that 90°<γ<180° is satisfied. The overall camera path can be made smooth by also making similar modifications to combinations of parameters adjacent to the previous and next, two combinations of parameters where the parameters are modified.

The camera path output unit 210 outputs virtual viewpoint images based on the camera path set by the camera path modification unit 205. The virtual viewpoint images based on the set camera path are output, for example, to a broadcasting system, a distribution system, and a replay video accumulation system.

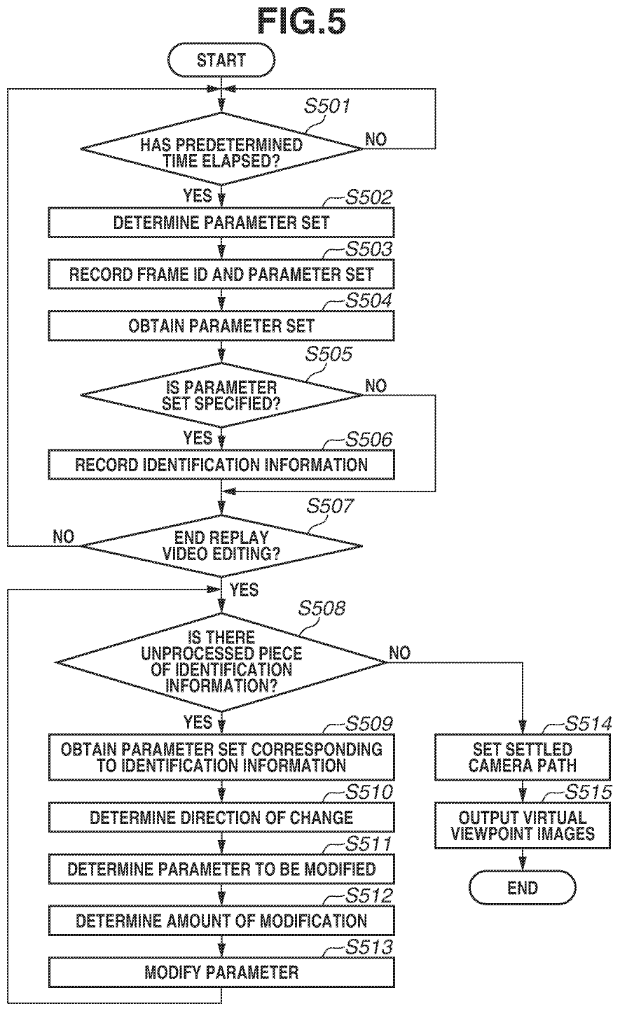

FIG. 5 is a flowchart illustrating a processing procedure of the information processing apparatus 100 according to the present exemplary embodiment. The following description will be given by using replay video editing as an example. In replay video editing, the camera operator operates the virtual camera 302 with a joystick and determines a camera path for generating a replay video image. The processing to be described with reference to FIG. 5 is started when the camera operator gives an instruction to start the replay video editing.

In step S501, the camera path determination unit 202 determines whether a predetermined time has elapsed. For example, if virtual viewpoint images are generated at 60 frames/sec, the camera path determination unit 202 determines whether 1/60 sec has elapsed. If 1/60 sec has elapsed (YES in step S501), the processing proceeds to step S502. In step S502, the camera path determination unit 202 determines a parameter set corresponding to a frame ID based on input by the camera operator. In step S503, the camera path determination unit 202 records the frame ID and the determined parameter set as part of a camera path. In step S504, the camera path obtaining unit 203 obtains the parameter set recorded in step S503. In step S505, the parameter set specification unit 204 determines whether the parameter set is specified based on input by the modification operator. If the parameter set is specified (YES in step S505), the processing proceeds to step S506. If the parameter set is not specified (NO in step S505), the processing proceeds to step S507. In step S506, the parameter set specification unit 204 records identification information (for example, the frame ID) about the specified parameter set. In step S507, the camera path determination unit 202 determines whether an instruction to end the replay video editing is given by the camera operator. If the instruction to end the replay video editing is given (YES in step S507), the processing proceeds to step S508. If the instruction to end the replay video editing is not given (NO in step S507), the processing returns to step S501. In the processing of steps S501 to S507, identification information and a parameter set corresponding to the identification information is determined at every 1/60 sec.

In step S508, the camera path modification unit 205 determines whether the identification information recorded in step S506 includes a piece of identification information that has not been processed in step S509 or the subsequent steps. If there is a piece of identification information that has not been processed in step S509 or the subsequent steps (YES in step S508), the processing proceeds to step S509. If all the pieces of identification information have been processed in step S509 and the subsequent steps (NO in step S508), the processing proceeds to step S514. In step S509, the camera path obtaining unit 203 obtains the parameter set corresponding to the identification information from the camera path determination unit 202. In step S510, the modification direction determination unit 206 determines the direction of change of the virtual camera 302 corresponding to the identification information. In step S511, the modification parameter determination unit 208 determines the parameter to be modified in the parameter set corresponding to the identification information. In step S512, the modification amount determination unit 209 determines the amount of modification to the parameter determined in step S511. In step S513, the camera path modification unit 205 modifies a parameter included in the parameter set corresponding to the identification information based on the direction of change of the virtual camera 302, the parameter to be modified, and the amount of modification to the parameter. In step S514, the camera path modification unit 205 sets the finally settled camera path. In step S515, the camera path output unit 210 outputs virtual viewpoint images based on the set camera path.

An example of editing a replay video image is described below. The camera operator determines a camera path by operating the camera controller 404 connected to the information processing apparatus 100. Virtual viewpoint images based on the determined camera path are displayed on the virtual viewpoint image display unit 401 based on the operations of the camera operator. The modification operator checks the virtual viewpoint images. If the modification operator determines to modify a virtual viewpoint image, the modification operator makes specification operations by operating the specification controller 403 connected to the information processing apparatus 100. If the camera operator gives an instruction to end the replay video editing, the camera path modification unit 205 modifies the parameters included in the parameter sets specified on the determined camera path. After the end of the modifications, the camera path modification unit 205 sets the settled camera path. The virtual viewpoint images based on the set camera path are transmitted to the broadcasting system, distribution system, and replay video image accumulation system, and are broadcast, distributed, and accumulated as a replay video image.

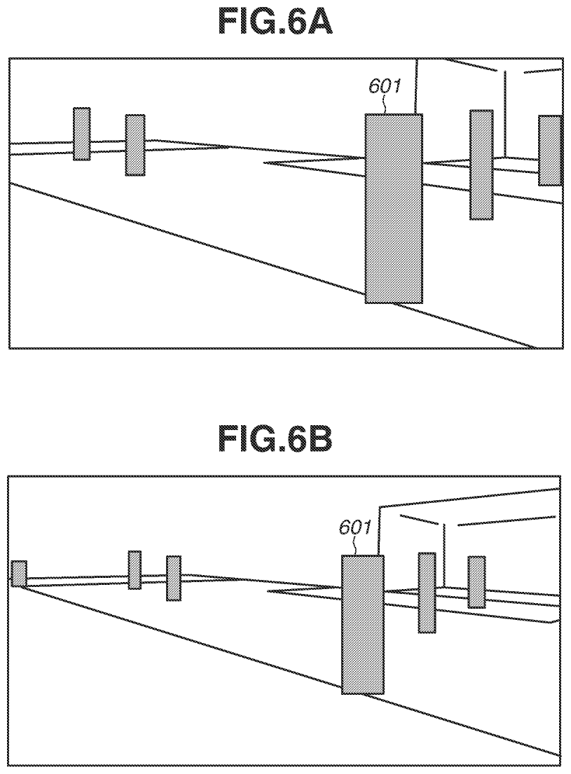

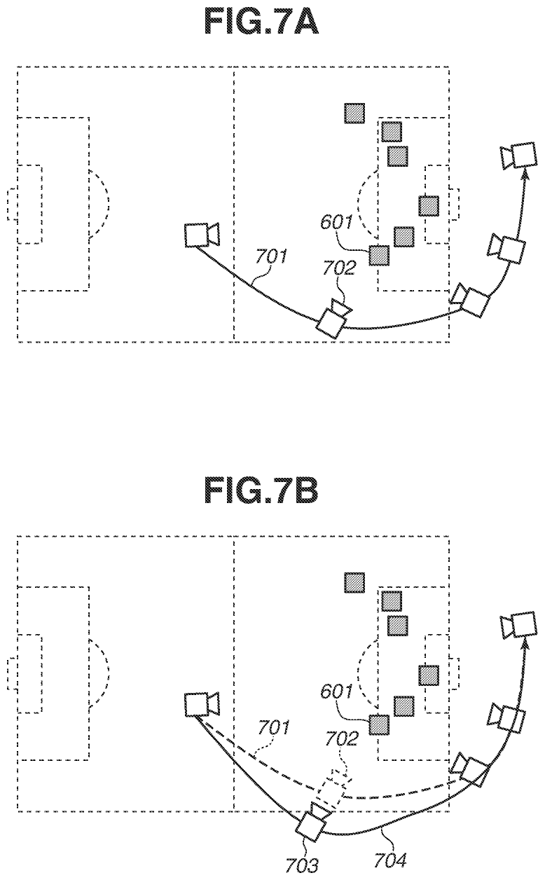

An example where the camera path is modified based on a determination made by the modification operator will be described with reference to FIGS. 6A, 6B, 7A, and 7B. For example, suppose that the modification operator determines that the image quality is degraded by too large a foreground region 601 in a virtual viewpoint image of FIG. 6A. FIG. 7A illustrates an overall camera path 701 generated by the camera operator, and a parameter (here, the “position” of the virtual camera 302) 702 included in the parameter set specified by the modification operator. The camera path modification unit 205 modifies the parameter 702 into a parameter 703 illustrated in FIG. 7B. By this modification, the overall camera path 701 is modified into a camera path 704. FIG. 6B illustrates a virtual viewpoint image corresponding to the parameter 703, where the foreground region 601 is smaller and the image quality is improved. On the other hand, if the modification operator determines to get a little closer to the foreground object to generate an impressive image, the modification operator specifies the “direction of making the foreground region greater” as the direction of change of the virtual camera 302 by using the specification controller 403. The camera path modification unit 205 modifies the parameters so that the foreground region in the virtual viewpoint image corresponding to the specification parameter set becomes greater. To generate an impressive virtual viewpoint image, the foreground region can be made as large as possible. However, too large a foreground region leads to low image quality. In such a case, an impressive virtual viewpoint image can be generated without lowering image quality, by determining the amount of modification so that the size of the foreground region in the virtual viewpoint coincides with the image quality limit size.

As described above, the camera path can be efficiently set in the replay video editing. As a result, virtual viewpoint images of high image quality can be quickly broadcast, distributed, and accumulated. In the present exemplary embodiment, determination operations for determining the camera path and specification operations for specifying virtual viewpoint parameter sets to be modified are described to be performed in parallel. However, this is not restrictive. For example, the information processing apparatus 100 may be configured so that specification operations are made on a camera path generated in advance. Examples of the camera path generated in advance include a camera path based on determination operations made in the past and a camera path automatically generated. In step S504 of FIG. 5, the camera path obtaining unit 203 obtains a camera path that is generated in advance and stored in a storage device inside or outside the information processing apparatus 100. With such a configuration, parameter sets specified by specification operations on the camera path generated in advance are modified.

In a second exemplary embodiment, another example of the processing for setting a camera path will be described. An information processing apparatus 100 according to the present exemplary embodiment has a similar hardware configuration and functional configuration to those in the first exemplary embodiment. A description thereof will thus be omitted.

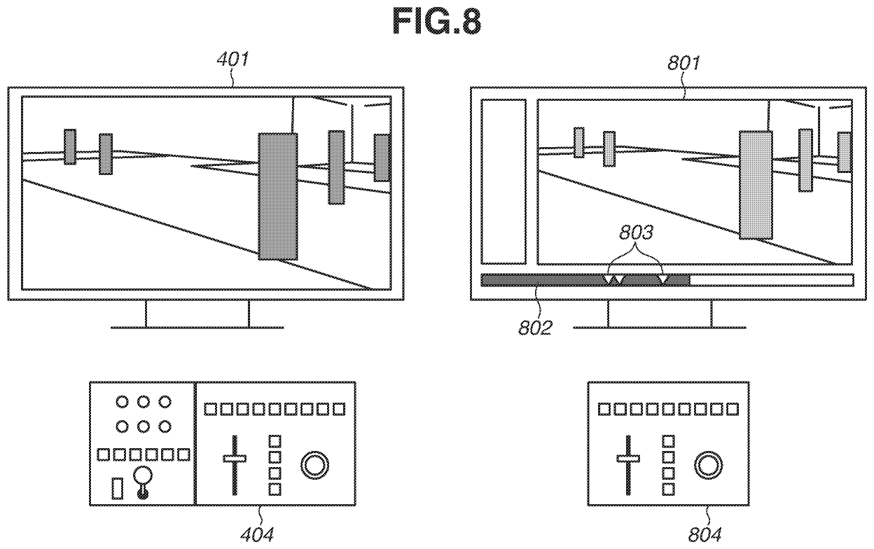

FIG. 8 is a diagram illustrating an example of a UI for setting a camera path by real-time processing. The camera operator makes determination operations by operating the camera controller 404 connected to the information processing apparatus 100. Virtual viewpoint images are displayed on the virtual viewpoint image display unit 401 based on the operations of the camera operator. The camera path obtaining unit 203 obtains the determined camera path, and adds the camera path to a timeline 802. A marker 803 indicates a position of a virtual viewpoint image on the camera path specified by the specification operations performed by the modification operator. The virtual viewpoint images are also displayed on a virtual viewpoint image display unit 801. The modification operator makes specification operations by operating a modification controller 804 connected to the information processing apparatus 100. The camera path modification unit 205 successively modifies the parameters included in parameter sets specified by the specification operations, and sets a settled camera path. The camera path output unit 210 outputs virtual viewpoint images based on the finally settled camera path. In other words, a video image based on the set camera path can be sequentially broadcast and distributed by modifying the camera path determined by the camera operator within a certain time. The modified camera path can be accumulated for rebroadcasting.

For example, the camera operator operating the virtual camera 302 can fail to follow the movement of the foreground object (such as a player), and as a result the image quality can degrade. Even in such a case, the camera path can be efficiently corrected by the operation of the modification operator, and virtual viewpoint images of high image quality can be quickly broadcast and distributed.

In a third exemplary embodiment, another example of the configuration and processing of the information processing apparatus 100 will be described.

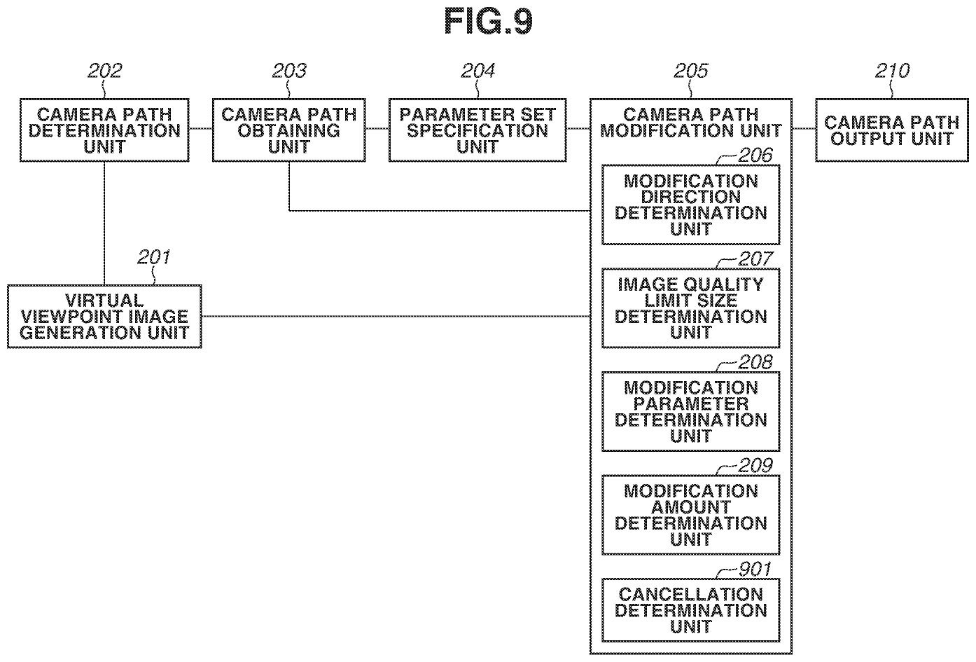

FIG. 9 is a diagram illustrating a functional configuration of an information processing apparatus 100 according to the present exemplary embodiment. A cancellation determination unit 901 is added to the functional configuration of the information processing apparatus 100 according to the first exemplary embodiment. In other respects, the hardware configuration and functional configuration are similar to those in the first exemplary embodiment.

The cancellation determination unit 901 determines whether to cancel a modification made to a parameter included in the parameter set specified by the parameter set specification unit 204. An example where a modification to a parameter is cancelled will be described below. In a case where a parameter set is specified by the parameter set specification unit 204, a parameter included in the specified parameter set is modified and a virtual viewpoint image corresponding to the modified parameter is generated. If the generated virtual viewpoint image includes a new foreground object corresponding to a foreground region, the cancellation determination unit 901 determines to cancel the modification to the camera path. If no new foreground object corresponding to a foreground region is included, the cancellation determination unit 901 determines not to cancel the modification.

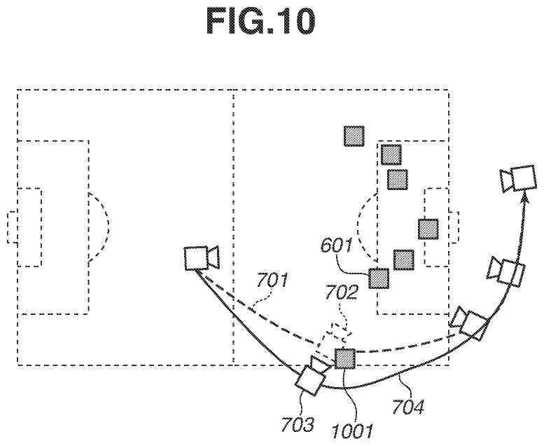

An example where a modification to the camera path is cancelled will be described with reference to FIG. 10. Suppose, in FIG. 10, that the foreground region 601 becomes too large in the virtual viewpoint image corresponding to the parameter 702 (here, the “position” of the virtual camera 302), and the parameter 702 is modified into the parameter 703. Suppose also that the virtual viewpoint image corresponding to the parameter 703 includes a new foreground object corresponding to a foreground region 1001. In such a case, since the position of the foreground object corresponding to the foreground region 1001 is close to the position of the virtual camera 302 corresponding to the parameter 703, the foreground region 1001 appears large in the virtual viewpoint image and the image quality drops compared to before the modification of the parameter 702. The additional drop in the image quality of the entire virtual viewpoint image can thus be prevented by cancelling the modification of the parameter into the parameter 703.

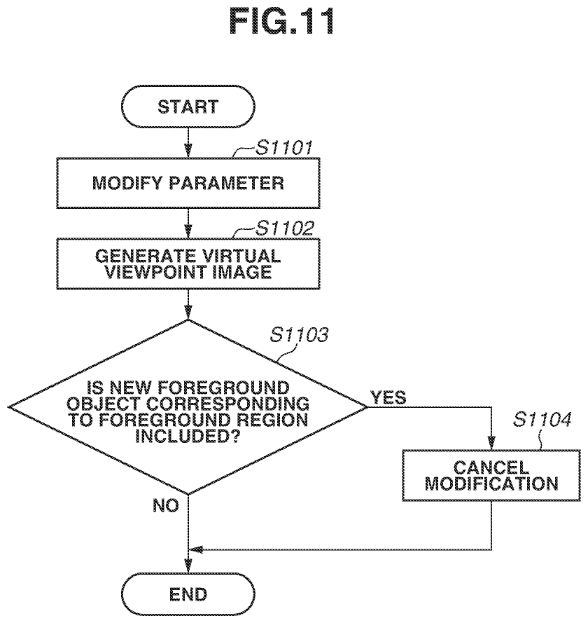

FIG. 11 is a flowchart illustrating a processing procedure of the information processing apparatus 100 according to the present exemplary embodiment. The processing illustrated in FIG. 11 replaces step S513 in the flowchart of FIG. 5. In step S1101, the camera path modification unit 205 modifies a parameter included in the parameter set corresponding to the identification information based on the direction of change of the virtual camera 302, the parameter to be modified, and the amount of modification to the parameter corresponding to the identification information. In step S1102, the image generation unit 201 generates a virtual viewpoint image based on the modified parameter. In step S1103, the cancellation determination unit 901 determines whether the generated virtual viewpoint image includes a new foreground object corresponding to a foreground region. If a new foreground object corresponding to a foreground region is included (YES in step S1103), the processing proceeds to step S1104. If no new foreground object corresponding to a foreground region is included (NO in step S1103), the processing ends. The processing then proceeds to step S507 in the flowchart of FIG. 5. In step S1104, the camera path modification unit 205 cancels the modification to the parameter included in the parameter set corresponding to the identification information. The processing ends. The processing then proceeds to step S507 in the flowchart of FIG. 5.

The case where the modification to a parameter is cancelled is not limited to the foregoing example. For example, the cancellation determination unit 901 may be configured to cancel a modification to a parameter based on input operations made by the camera operator. The cancellation determination unit 901 may be configured so that its determination criteria can be freely set by the user.

In the description of FIG. 11, the processing for generating a virtual viewpoint image based on the modified camera path and determining whether to cancel the modification to the camera path based on the virtual viewpoint image has been described. However, this example is not restrictive. Specifically, the cancellation determination unit 901 can determine whether to cancel the modification to the camera path without generating a virtual viewpoint image based on the modified camera path. For example, the cancellation determination unit 901 can determine whether to cancel the modification to the camera path by referring to the bird's eye view image illustrated in FIG. 10, without generating a virtual viewpoint image based on the modified camera path. If the positions of the foreground objects corresponding to the respective foreground regions are known, the cancellation determination unit 901 can determine whether to cancel the modification to the camera path without referring to the bird's eye view image illustrated in FIG. 10 or generating a virtual viewpoint image based on the modified camera path. It should be noted that there can be various such modifications of the method for cancellation determination. Methods that generate a virtual viewpoint image based on the modified camera path have the following advantage. If the virtual viewpoint image is output to the output device 106 in cancelling the modification to the camera path, for example, the modification operator can readily understand why the modification is cancelled. On the other hand, methods that determine whether to cancel the modification without generating a virtual viewpoint based on the modified camera path have the advance that the processing load of the determination can be reduced.

### Other Exemplary Embodiments

An exemplary embodiment of the present disclosure can also be implemented by processing for supplying a program for implementing one or more of the functions of the foregoing exemplary embodiments to a system or an apparatus via a network or a storage medium, and reading and executing the program by one or more processors of a computer in the system or apparatus. A circuit for implementing one or more of the functions (for example, ASIC) may be used for implementation.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2019-033570, filed Feb. 27, 2019, which is hereby incorporated by reference herein in its entirety.

What is claimed is:

1. An information processing apparatus comprising:
an obtaining unit configured to obtain a virtual viewpoint parameter set including at least either a virtual viewpoint parameter indicating a position of a virtual viewpoint or a virtual viewpoint parameter indicating a direction from the virtual viewpoint, the virtual viewpoint being related to a virtual viewpoint image based on a plurality of captured images obtained by capturing images of an imaging area in different directions by a plurality of imaging apparatuses; and
a modification unit configured to modify the virtual viewpoint parameter(s) included in the virtual viewpoint parameter set obtained by the obtaining unit based on a user operation made after the virtual viewpoint parameter set is obtained by the obtaining unit and information for determining a size of a foreground region corresponding to a predetermined object in the imaging area, the foreground region being included in the virtual viewpoint image corresponding to the virtual viewpoint parameter set obtained by the obtaining unit.

2. The information processing apparatus according to claim 1, wherein the information for determining the size of the foreground region includes information indicating a positional relationship between the predetermined object and the virtual viewpoint indicated by the virtual viewpoint parameter set obtained by the obtaining unit.

3. The information processing apparatus according to claim 1, wherein the information for determining the size of the foreground region includes a virtual viewpoint parameter corresponding to an angle of view at the virtual viewpoint, the virtual viewpoint parameter being included in the virtual viewpoint parameter set obtained by the obtaining unit.

4. The information processing apparatus according to claim 1, wherein the information for determining the size of the foreground region includes information indicating an area of the foreground region in the virtual viewpoint image corresponding to the virtual viewpoint parameter set obtained by the obtaining unit.

5. The information processing apparatus according to claim 1, further comprising a display control unit configured to control display of the virtual viewpoint image on a display unit, the virtual viewpoint image being generated based on the virtual viewpoint parameter set obtained by the obtaining unit.

6. The information processing apparatus according to claim 5, wherein the user operation is made while the virtual viewpoint image corresponding to the virtual viewpoint parameter set obtained by the obtaining unit is displayed.

7. The information processing apparatus according to claim 1, further comprising a display control unit configured to control display of a numerical value or values indicating the virtual viewpoint parameter(s) included in the virtual viewpoint parameter set obtained by the obtaining unit on a display unit.

8. The information processing apparatus according to claim 1, wherein the obtaining unit is configured to obtain the virtual viewpoint parameter set determined based on a user operation different from the user operation.

9. The information processing apparatus according to claim 8,
wherein the virtual viewpoint parameter set includes the virtual viewpoint parameter indicating the position of the virtual viewpoint, and
wherein the user operation includes an operation for specifying modification of the virtual viewpoint parameter indicating the position of the virtual viewpoint, the virtual viewpoint parameter being included in the virtual viewpoint parameter set.

10. The information processing apparatus according to claim 8,
wherein the virtual viewpoint parameter set includes a virtual viewpoint parameter indicating an angle of view at the virtual viewpoint, and
wherein the user operation includes an operation for specifying modification of the virtual viewpoint parameter indicating the angle of view at the virtual viewpoint, the virtual viewpoint parameter being included in the virtual viewpoint parameter set.

11. The information processing apparatus according to claim 8, wherein the user operation includes an operation for specifying modification of the virtual viewpoint parameter(s) included in the virtual viewpoint parameter set so that the size of the foreground region in the virtual viewpoint image based on the virtual viewpoint parameter(s) modified by the modification unit changes.

12. The information processing apparatus according to claim 1, wherein the obtaining unit is configured to obtain a plurality of virtual viewpoint parameter sets representing transition of the virtual viewpoint.

13. The information processing apparatus according to claim 1, wherein the user operation is an operation for giving an instruction to modify the virtual viewpoint parameter(s) included in the virtual viewpoint parameter set obtained by the obtaining unit.

14. The information processing apparatus according to claim 1, wherein the modification unit is configured to,
in a case where the size of the foreground region based on the information for determining the size of the foreground region in the virtual viewpoint image corresponding to the virtual viewpoint parameter set obtained by the obtaining unit is greater than a predetermined threshold, modify the virtual viewpoint parameter(s) included in the virtual viewpoint parameter set to make the foreground region smaller, and
in a case where the size of the foreground region based on the information for determining the size of the foreground region in the virtual viewpoint image corresponding to the virtual viewpoint parameter set obtained by the obtaining unit is smaller than the predetermined threshold, modify the virtual viewpoint parameter(s) included in the virtual viewpoint parameter set to make the foreground region greater.

15. The information processing apparatus according to claim 1, further comprising a cancellation unit configured to cancel modification made to the virtual viewpoint parameter(s) by the modification unit.

16. The information processing apparatus according to claim 15, wherein the cancellation unit is configured to determine whether to cancel the modification based on the virtual viewpoint image corresponding to the virtual viewpoint parameter set including the virtual viewpoint parameter(s) modified by the modification unit.

17. An information processing method comprising:
obtaining a virtual viewpoint parameter set including at least either a virtual viewpoint parameter indicating a position of a virtual viewpoint or a virtual viewpoint parameter indicating a direction from the virtual viewpoint, the virtual viewpoint being related to a virtual viewpoint image based on a plurality of captured images obtained by capturing images of an imaging area in different directions by a plurality of imaging apparatuses; and
modifying the virtual viewpoint parameter(s) included in the obtained virtual viewpoint parameter set based on a user operation made after the virtual viewpoint parameter set is obtained and information for determining a size of a foreground region corresponding to a predetermined object in the imaging area, the foreground region being included in the virtual viewpoint image corresponding to the obtained virtual viewpoint parameter set.

18. A non-transitory computer-readable storage medium storing a program for causing a computer to execute an information processing method, the method comprising:
obtaining a virtual viewpoint parameter set including at least either a virtual viewpoint parameter indicating a position of a virtual viewpoint or a virtual viewpoint parameter indicating a direction from the virtual viewpoint, the virtual viewpoint being related to a virtual viewpoint image based on a plurality of captured images obtained by capturing images of an imaging area in different directions by a plurality of imaging apparatuses; and
modifying the virtual viewpoint parameter(s) included in the obtained virtual viewpoint parameter set based on a user operation made after the virtual viewpoint parameter set is obtained and information for determining a size of a foreground region corresponding to a predetermined object in the imaging area, the foreground region being included in the virtual viewpoint image corresponding to the obtained virtual viewpoint parameter set.
